(19) United States
(12) Patent Application Publication
(10) Pub. No.: US 2004/0241328 A1
(43) Pub. Date: Dec. 2, 2004

(54) Method and adhesive applicator unit for continuous application of adhesive to webs

(75) Inventors: Edmund Bradatsch, Weiden (DE); Hans Mosburger, Weiherhammer (DE); Markus Fischer, Mantel (DE)

Correspondence Address: BROWDY AND NEIMARK, P.L.L.C., 624 NINTH STREET, NW, SUITE 300, WASHINGTON, DC, 20001-5303, US

(73) Assignee: BHS Corrugated Maschinen-und Anlagenbau GMBH, Weiherhammer (DE)

(21) Appl. No.: 10/855,842

(22) Filed: May 28, 2004

(30) Foreign Application Priority Data
May 31, 2003 (DE) 103 24 729.7

(51) Int. Cl. B05D 3/12

(52) U.S. Cl. 427/356; 156/210; 156/470

(57) ABSTRACT

An adhesive applicator unit for a web of corrugated board comprises a frame which houses an adhesive applicator roll, and an adhesive pre-metering roll which is disposed underneath the applicator roll, and an adhesive re-metering roll which is disposed by the side of the applicator roll, each of which is rotatably drivably mounted. Formed between the adhesive pre-metering roll and the adhesive applicator roll is an adhesive pre-metering nip where pre-metering of the adhesive takes place. Between the adhesive applicator roll and the adhesive re-metering roll, provision is made for an adhesive re-metering nip where final re-metering and calibration of the adhesive film takes place.

### BACKGROUND OF THE INVENTION

1. Field of the Invention

The invention relates to a method of continuously applying adhesive to webs, in particular to the corrugation tips of webs of corrugated board; and to an adhesive applicator unit for putting the method into practice. Webs of single-faced corrugated board of the generic type include a sheet of corrugated paper and a liner that covers the sheet unilaterally. The method and the adhesive applicator unit according to the invention serve in particular for applying adhesive to the tips, turned away from the liner, of the web of corrugated paper, which is then glued to another liner or to another web of single-faced corrugated board in a so-called heating section.

2. Background Art

An adhesive applicator unit of the generic type known from EP 0 179 395 A1 comprises an adhesive applicator roll which is stored in a frame and the bottom area of which dips into an adhesive pan. An adhesive doctor roll is provided, which is approximately horizontally level with the axis of the adhesive applicator roll and which is disposed over the adhesive pan above the adhesive level. Adhesive consumption is comparatively high, metering the adhesive and setting the thickness of the adhesive layer on the applicator roll being rather inaccurate. German published patent application 1 436 896 teaches a comparable adhesive applicator unit. DE 40 18 426 C2 teaches an adhesive applicator unit for an apparatus for the manufacture of a web of single-faced corrugated board, in which an adhesive applicator roll and a doctor roll are provided. By means of the adhesive applicator roll, adhesive is applied to the tips of a web of corrugated paper that rests on a fluted roll. An adhesive supply pan is provided, which is open towards the adhesive applicator roll. The adhesive is doctored off downwards by an adhesive doctor nip between the rolls and supplied to the web of corrugated paper located on the fluted roll. This adhesive applicator unit does not permit the thickness of the film of adhesive on the adhesive applicator roll to be set accurately; as a result, adhesive consumption is comparatively high.

### SUMMARY OF THE INVENTION

It is an object of the invention to embody a method and an adhesive applicator unit which excel by extremely low and precisely adjustable consumption of adhesive.

According to the invention, this object is attained in a method of continuously applying adhesive to corrugation tips of webs of corrugated board, wherein adhesive is delivered from a supply of adhesive into an adhesive pre-metering nip where it is pre-metered; wherein the pre-metered adhesive is re-metered in an adhesive re-metering nip which is disposed downstream of the adhesive pre-metering nip; and wherein the re-metered adhesive is applied to the corrugation tips. It is attained by the aid of an adhesive applicator unit comprising a frame; an adhesive applicator roll which is mounted in the frame and rotatably drivable in a first direction of rotation; an adhesive pre-metering roll, which is mounted in the frame below the adhesive applicator roll and rotatably drivable in a second direction of rotation, combining with the adhesive applicator roll to define an adhesive pre-metering nip; an adhesive re-metering roll downstream of the adhesive pre-metering roll in the first direction of rotation, combining with the adhesive applicator roll to define an adhesive re-metering nip; and at least one adhesive pan which the adhesive pre-metering roll dips into at least partially. The thickness of the film of adhesive on the applicator roll is precisely given by the adhesive pre-metering nip. The film of adhesive is re-metered and equalized by the adhesive re-metering roll. This enables the adhesive to be metered highly accurately.

In keeping with an advantageous embodiment, the adhesive level is located by some minor distance below the adhesive pre-metering nip so that the influence of gravity on adhesive delivery through the adhesive pre-metering nip is rather insignificant.

Further details, features and advantages of the invention will become apparent from the ensuing description of two exemplary embodiments, taken in conjunction with the drawing.

### BRIEF DESCRIPTION OF THE DRAWING

FIG. 1 is a diagrammatic side view of a first embodiment of an adhesive applicator unit with a side wall removed;

FIG. 2 is a partial plan view of the adhesive applicator unit in accordance with the arrow II of FIG. 1;

FIG. 3 is a partial longitudinal view of the adhesive applicator unit in accordance with the arrow III of FIG. 1;

FIG. 4 is a view, corresponding to FIG. 1, of a second embodiment of an adhesive applicator unit;

FIG. 5 is a view, corresponding to FIG. 1, of a third embodiment of an adhesive applicator unit; and

FIG. 6 is a view, corresponding to FIG. 1, of a fourth embodiment of an adhesive applicator unit.

### DESCRIPTION OF PREFERRED EMBODIMENTS

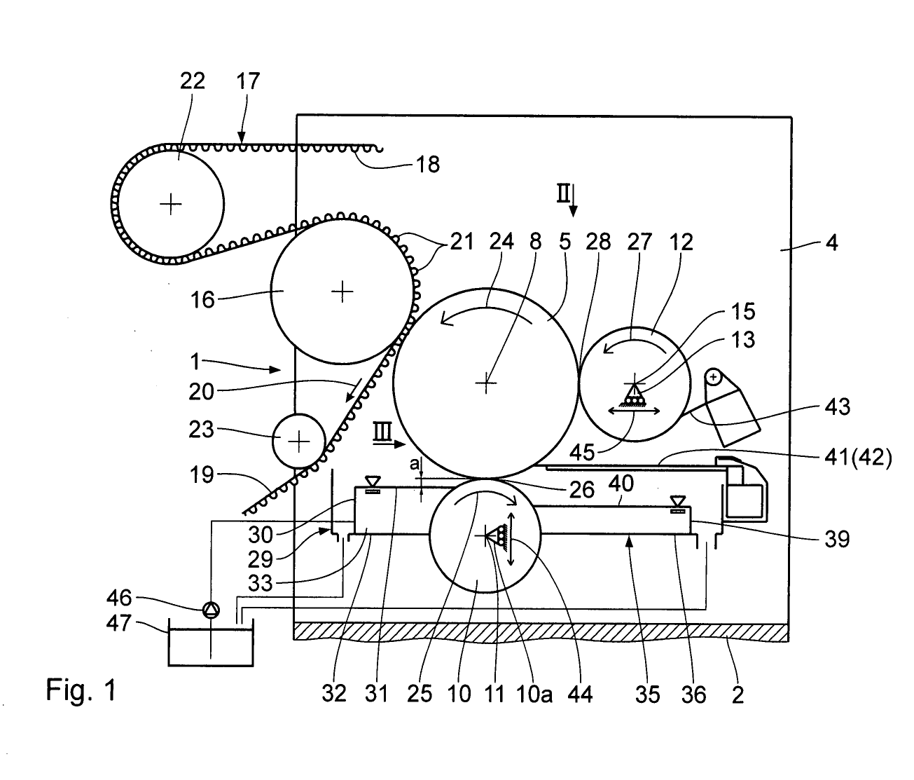

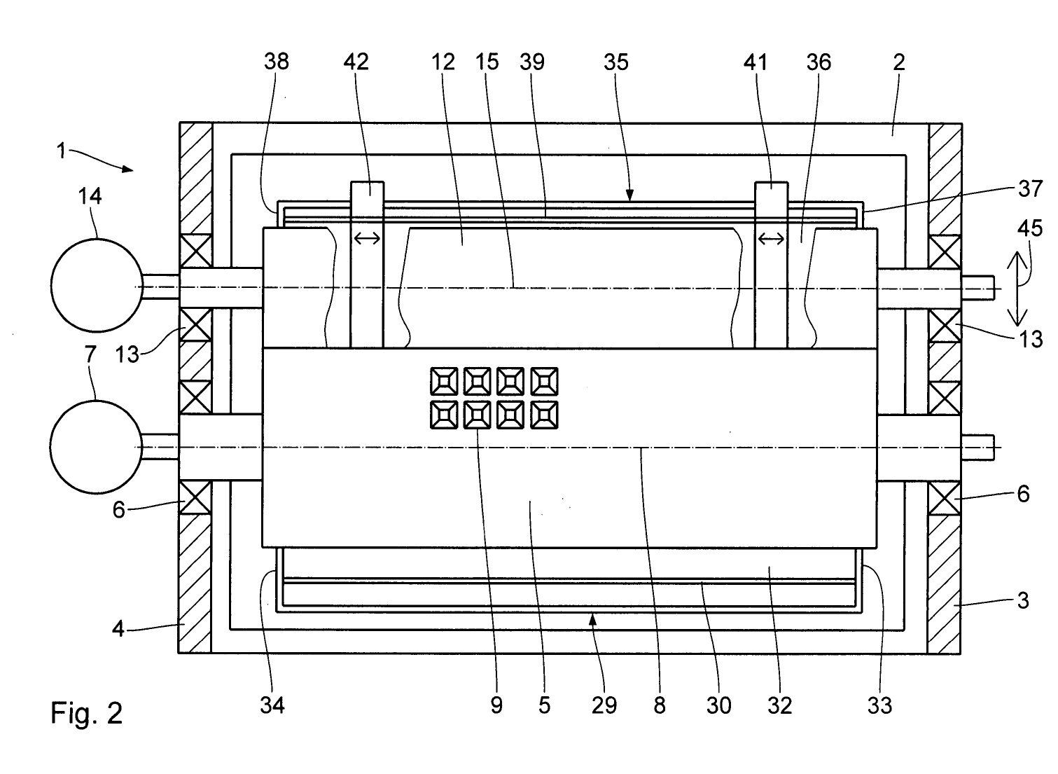

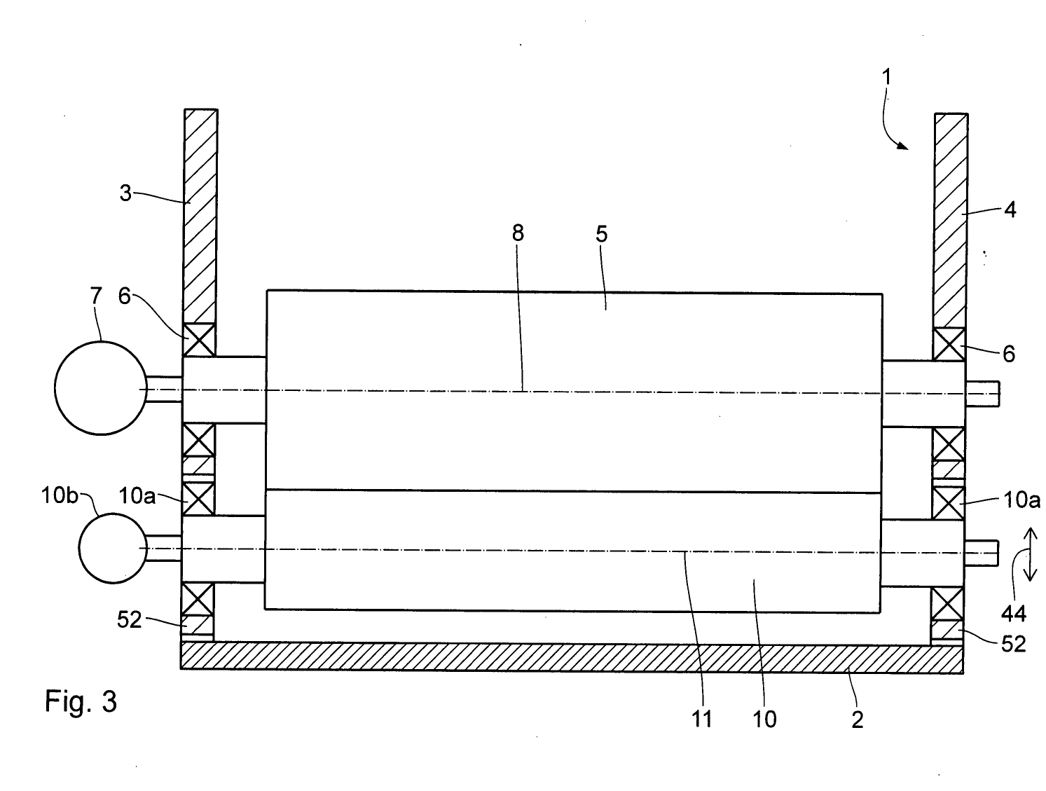

The adhesive applicator unit seen in FIGS. 1 to 3, comprises a frame 1, which has a bottom base plate 2 and two parallel side walls 3, 4. An adhesive applicator roll 5 is rotatably mounted in bearings 6 in the side walls 3, 4. It is drivable for rotation about its central longitudinal axis 8 by means of a motor 7. The applicator roll 5 has a structured surface with minute cells i.e., minute depressions 9, closely adjoining on the surface, which are roughly outlined in FIG. 2 on a strongly enlarged scale. Below the applicator roll 5, provision is made for a bottom adhesive pre-metering roll 10, which is also mounted for rotation about its central longitudinal axis 11 in bearings 10a in the form of sliding bearings that are located in the side walls 3, 4 of the frame 1. The roll 10 is rotarily drivable by a motor 10b. The two axes 8, 11 are located substantially on a common vertical plane.

A doctor roll 12 that serves as an adhesive re-metering roll is mounted in bearings 13 in the form of sliding bearings in the side walls 3, 4 of the frame 1; it is rotarily drivable about its central longitudinal axis 15 by means of a motor 14. The axes 8, 15 are on a joint horizontal plane. On the side turned away from the doctor roll 12, a nip roll 16 is stored freely rotatably in a movable mount (not shown) which is again mounted in the side walls 3, 4 of the frame 1. A web of single-faced corrugated board 17 is led around the nip roll 16. This web of corrugated board 17 comprises a web of corrugated paper 18 and a liner 19 that is glued on the web 18, covering it unilaterally. The web of corrugated board 17 is led along the nip roll 16 in the conveying direction 20 in such a way that the liner 19 rests on the nip roll 19 and the free corrugation tips 21 of the web of corrugated paper 18 rest on the applicator roll 5. Seen in the conveying direction 20, a lead roll 22 is disposed upstream of the nip roll 16 and a deflection roll 23, or deflection pipe, is disposed downstream thereof.

The applicator roll 5 is driven in a direction of rotation 24 which corresponds to the direction of rotation 20 of the web of corrugated board 17 at the point of contact between the web of corrugated board 17 and the applicator roll 5. The driving speed is such that it is identical with the conveying speed of the web of corrugated board 17, ensuring freedom from slippage thereof. However, the applicator roll 5 may also be driven at a higher or lower peripheral speed than the conveying speed of the web of single-faced corrugated board 17, having effect on the application of adhesive. The adhesive pre-metering roll 10 rotates in a direction of rotation 25 that is opposite to the direction of rotation 24, the applicator roll 5 and the pre-metering roll 10 having the same motional direction at the adhesive pre-metering nip 26 they define. The doctor roll 12 is driven in the same direction of rotation 27 as the direction of rotation 24 of the applicator roll 5 so that the applicator roll 5 and the doctor roll 12 have opposite motional directions at the doctor nip 28 they define, which serves as an adhesive re-metering nip. Seen in the direction of rotation 25 of the pre-metering roll 10 in the pre-metering nip 26, an adhesive supply pan 29 is disposed upstream of the nip 26, having an adhesive overflow 30 that is disposed by some minor distance a, of for instance 10 to 50 millimeters, underneath the adhesive pre-metering nip 26 so that the level 31 of adhesive in the supply pan 29 is below the pre-metering nip 26 only by this insignificant distance. Consequently, the adhesive overflow 30 is a device for keeping the adhesive level 31 constant. The supply pan 29, by its bottom 32 and side walls 33, 34, rests closely on the adhesive pre-metering roll 10 so that the adhesive, in the vicinity of the supply pan 29, is in direct contact with the pre-metering roll 10 as illustrated in FIG. 1.

On the side turned away from the adhesive supply pan 29 i.e., underneath the doctor roll 12, provision is made for an adhesive collecting pan 35, the bottom 36 and side walls 37, 38 of which also rest closely on the pre-metering roll 10. The collecting pan 35 too has an adhesive overflow 39 which lies below the level of the overflow 30. The height of this adhesive overflow 39 defines the adhesive level 40 in the collecting pan 35. Two wipers 41, 42 are mounted on the collecting pan 35; they are adjustable in the direction of the axis 15 and bear against the applicator roll 5 down-stream of the nip 26 seen in the direction of rotation 24, 25 in the nip 26. They wipe off any adhesive located on the applicator roll 5 across a width of few centimeters, for example five centimeters. The wipers 41, 42 are adjusted such that there is no, or only reduced, gluing of the corrugation tips 21 of the web of corrugated paper 18 in the marginal areas of the web of corrugated board 17.

A scraper 43, or doctor, conventionally bears against the doctor roll 12—downstream of the nip 28 seen in the direction of rotation 27 of the doctor roll 12 at the doctor nip 28—scraping off any adhesive that is located on the doctor roll 12 downstream of the nip 28, the adhesive flowing into the collecting pan 35.

On the vertical plane formed by the axes 8, 11, the bottom adhesive pre-metering roll 10 can be set in a vertical setting direction 44 in relation to the applicator roll 5 by means of the adjustable bearings 10a in the form of sliding bearings in such a way that the adhesive pre-metering nip 26 has a width of 0.15 to 0.85 millimeters. Due to the doctor roll 12 being horizontally adjustable relative to the applicator roll 5 on the plane formed by the axes 8, 15 i.e., in a horizontal setting direction 45, the adhesive doctor nip 28 can be set to have a width of 0.1 to 0.8 millimeters. The speeds of the applicator roll 5 and the doctor roll 12 can be set such that the following applies to the relationship of the peripheral speed v₅ of the applicator roll 5 to the peripheral speed v₁₂ of the doctor roll 12 at the doctor nip 28: 1.0≦v₅/v₁₂≦4.0. As a result of the described steps, film thicknesses of adhesive on the applicator roll 5 can be obtained that range from 0 to 0.4 millimeters. A film thickness of 0 millimeters exists when adhesive is located only in the depressions 9 i.e., in the cells of the structure.

The adhesive is supplied from a reservoir 47 to the adhesive supply pan 29 by means of a pump 46. This is also the reservoir 47 to which the adhesive flows back that has run off the adhesive overflow 30 and the adhesive overflow 39.

Provision can be made for a measuring device as an instrument for keeping the adhesive level 37 constant, which measures the height of the adhesive level 31 and triggers the pump 46 so that the level is kept constant. In this case, an adhesive overflow 30 is not necessary.

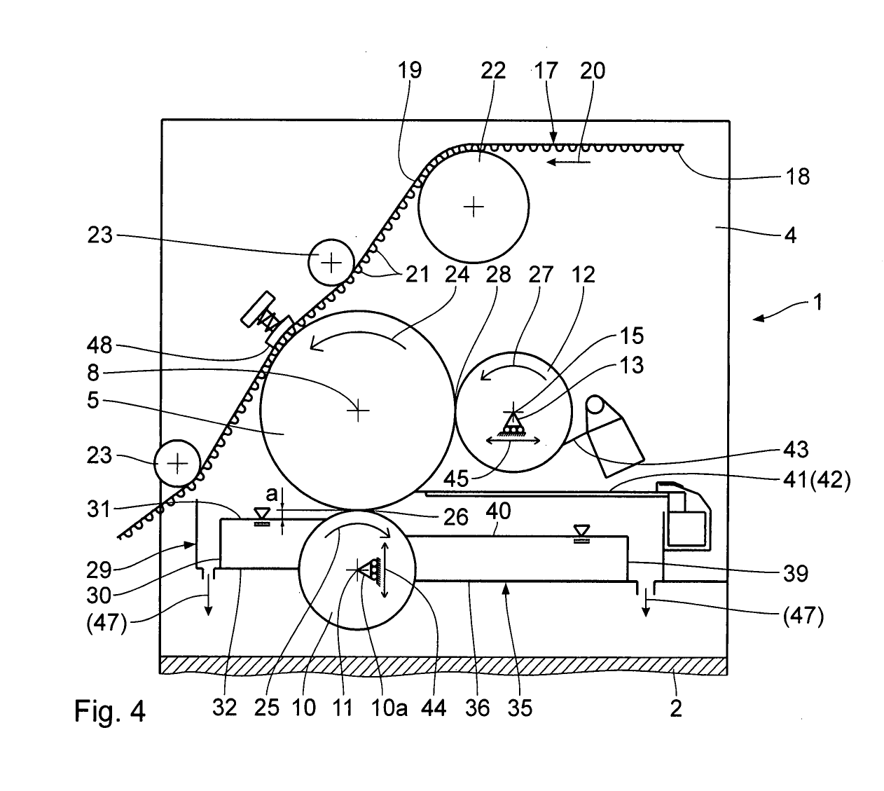

The embodiment according to FIG. 4 differs from that according to FIGS. 1 to 3 only in that so-called nip pressure saddles 48 are provided in the place of a nip roller, by means of which to press the web of corrugated board 17 resiliently against the applicator roll 5.

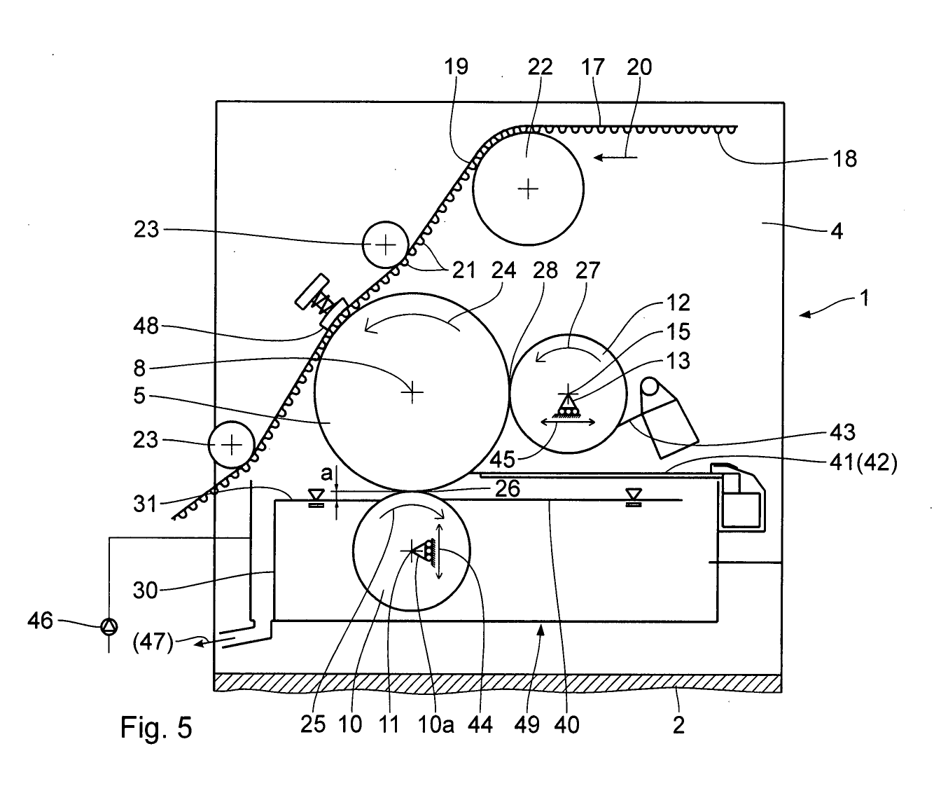

The embodiment according to FIG. 5 differs from that according to FIG. 4 in that a single adhesive pan 49 is provided instead of an adhesive supply pan and an adhesive collecting pan, the adhesive pre-metering roll 10 dipping into this pan 49.

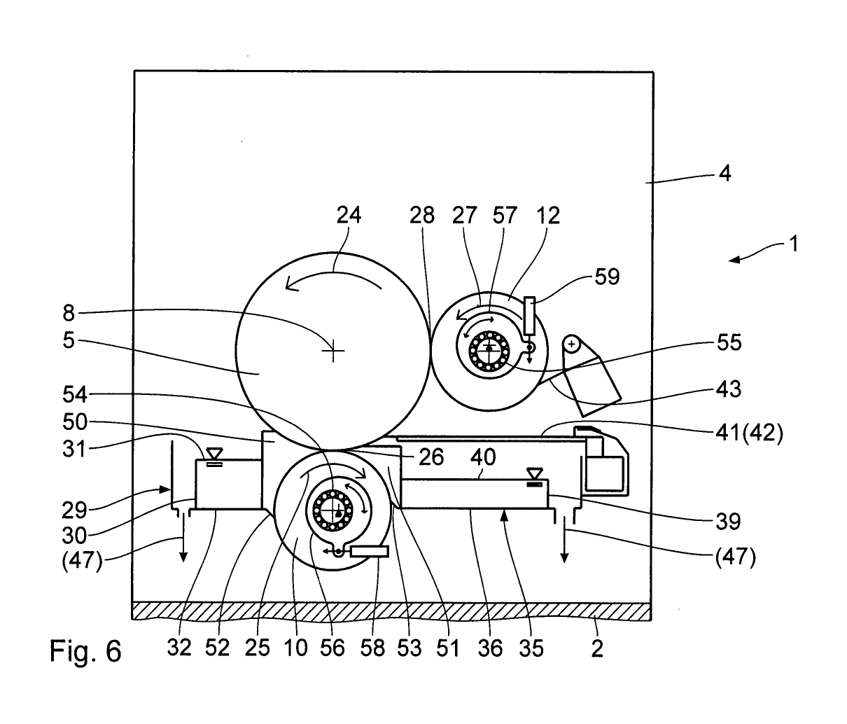

The embodiment according to FIG. 6 only shown the adhesive applicator unit without the nip roll and without nip pressure saddles. Lateral seals 50, 51 of the adhesive supply pan 29 and of the adhesive collecting pan 35 are illustrated, bearing resiliently against the adhesive pre-metering roll 10. The bottoms 32 and 36 of the adhesive supply pan 29 and the adhesive collecting pan 35 rest on the surface of the pre-metering roll 10, working as scrapers 52 and 53.

As further seen in FIG. 6, the bearing 54 of the pre-metering roll 10 and the bearing 55 of the doctor roll 12 can be set by means of eccentrics 56 and 57, whereby to modify the width of the adhesive pre-metering nip 26 and of the doctor nip 28. As specified above, the nips 26 and 28 are very small; modifications in width will be even smaller. Linear drives 58 and 59 can be provided for setting the eccentrics 56, 57.

The described variations can be used optionally in the various embodiments.

An adhesive applicator unit of the type specified is arranged upstream of a so-called heating section where the web of single-faced corrugated board 17 is coated with another web of corrugated board of this type and/or with another liner. Arrangements of this type are known for example from EP0 179 395 A.

The mode of operation is as follows:

Adhesive is taken from the adhesive supply pan 29 by the pre-metering roll 10 and transported in the direction of rotation 25 thereof; it is pre-metered in the adhesive pre-metering nip 26 where part of the amount of adhesive supplied to the pre-metering nip 26 is led off. The adhesive transferred to the adhesive applicator roll 5 in the adhesive pre-metering nip 26 is transported by the adhesive applicator roll 5 in the direction of rotation 24 thereof and re-metered, i.e. calibrated, in the doctor nip 28, its thickness being set accurately. In the process, excess adhesive is led off for a second time. To this end, the adhesive pre-metering nip 26 must always have a width that exceeds the width of the adhesive doctor nip 26, the difference in nip width ranging from approximately 0.05 to 0.1 mm.

Prior to doctoring, a surface area that is largely free from adhesive is produced by the wipers 41, 42 on the applicator roll 5. The adhesive on the applicator roll 5 downstream of the doctor nip 28 is transferred to the corrugation tips 21 of the web of corrugated paper 18.

Due to the fact that the adhesive level 31 is located below the adhesive pre-metering nip 26 by the distance a of only few millimeters, the influence of gravity on adhesive delivery by the pre-metering roll 10 as far as into the pre-metering nip 26 is eliminated nearly completely. As a result, the bottom adhesive pre-metering roll 10 can rotate at a very low peripheral speed of for example 20 m/min in any of the nip and speed settings of the type mentioned. Fundamentally, any peripheral speed of the pre-metering roll 10 will do. The adhesive pre-metering nip 26 will always be sufficiently filled with adhesive. This possibility of low peripheral speed of the adhesive pre-metering roll 10 ensures that the adhesive level 31 in the adhesive supply pan 29 is kept rather calm and smooth, facilitating the measuring of adhesive consumption and improving the precision thereof.

With the applicator roll 5 and the pre-metering roll 10 rotating in the same direction at the pre-metering nip 26, the adhesive delivered by the pre-metering roll 10 is uniformly spread on the applicator roll 5.

The doctor roll 12 is cleaned by the scraper 43. The stripes free from adhesive that are produced by the wipers 41, 42 on the applicator roll 5 help avoid dry operation of the applicator roll 5 beyond the width of the web of corrugated board 17.

What is claimed is:

1. A method of continuously applying adhesive to corrugation tips (21) of webs of corrugated board (17),
wherein adhesive is delivered from a supply of adhesive into an adhesive pre-metering nip (26) where it is pre-metered;
wherein the pre-metered adhesive is re-metered in an adhesive re-metering nip (28) which is disposed downstream of the adhesive pre-metering nip (26); and
wherein the re-metered adhesive is applied to the corrugation tips (21).

2. A method according to claim 1,
wherein the adhesive is re-metered by doctoring.

3. A method according to claim 1,
wherein the adhesive pre-metering nip (26) is defined by walls that are moved in same directions.

4. A method according to claim 1,
wherein the adhesive re-metering nip (28) is defined by walls that are moved in opposite directions.

5. A method according to claim 3,
wherein the adhesive pre-metering nip (26) is defined by an adhesive pre-metering roll (10) and an adhesive applicator roll (5).

6. A method according to claim 4,
wherein the adhesive re-metering nip (28) is defined by an adhesive re-metering roll (12) and an adhesive applicator roll (5).

7. A method according to claim 1,
wherein the adhesive pre-metering nip (26) is adjustable in width.

8. A method according to claim 7,
wherein the width of the adhesive pre-metering nip (26) is adjustable in a range from 0.15 to 0.85 mm.

9. A method according to claim 1,
wherein the adhesive re-metering nip (28) is adjustable in width.

10. A method according to claim 9,
wherein the width of the adhesive re-metering nip (28) is adjustable in a range from 0.1 to 0.8 mm.

11. A method according to claim 1,
wherein the adhesive is delivered from the adhesive supply by a distance a upwards into the adhesive pre-metering nip (26).

12. A method according to claim 11,
wherein 10 mm≦a≦50 mm applies to the distance a.

13. A method according to claim 6,
wherein the adhesive applicator roll (5) is moved at a peripheral speed v₅ and the adhesive re-metering roll (12) is moved at a speed v₁₂; and in that 1.0≦v₅/v₁₂≦4.0 applies to the relationship of v₅ and v₁₂.

14. An adhesive applicator unit for continuously applying adhesive to corrugation tips (21) of webs of corrugated board (17),
wherein adhesive is delivered from a supply of adhesive into an adhesive pre-metering nip (26) where it is pre-metered;
wherein the pre-metered adhesive is re-metered in an adhesive re-metering nip (28) which is disposed downstream of the adhesive pre-metering nip (26); and
wherein the re-metered adhesive is applied to the corrugation tips (21); said unit comprising
a frame (1);
an adhesive applicator roll (5) which is mounted in the frame (1) and rotatably drivable in a first direction of rotation (24);
an adhesive pre-metering roll (10), which is mounted in the frame (1) below the adhesive applicator roll (5) and rotatably drivable in a second direction of rotation (25), combining with the adhesive applicator roll (5) to define an adhesive pre-metering nip (26);
an adhesive re-metering roll (12) downstream of the adhesive pre-metering roll (10) in the first direction of rotation (24), combining with the adhesive applicator roll (5) to define an adhesive re-metering nip (28) having a width; and
at least one adhesive pan (29, 35; 49) which the adhesive pre-metering roll (10) dips into at least partially.

15. An adhesive applicator unit according to claim 14,
wherein devices are provided for maintenance of an adhesive level (31) at a minor vertical distance a from the adhesive pre-metering nip (26).

16. An adhesive applicator unit according to claim 15,
wherein 10≦a≦50 mm applies to the vertical distance a.

17. An adhesive applicator unit according to claim 14,
wherein the width of the adhesive re-metering nip (28) is less than the width of the adhesive pre-metering nip (26).

18. An adhesive applicator unit according to claim 14,
wherein an adhesive supply pan (29) is provided, which is open laterally towards the adhesive pre-metering roll (10) and which is disposed up-stream of the adhesive pre-metering nip (26) seen in the second direction of rotation (25).

19. An adhesive applicator unit according to claim 18,
wherein an adhesive collecting pan (35) is provided, which is open laterally towards the adhesive pre-metering roll (10) and which is disposed down-stream of the adhesive pre-metering nip (26) seen in the second direction of rotation (25).

20. An adhesive applicator unit according to claim 14,
wherein the adhesive pre-metering roll (10) is adjustable in a vertical setting direction (44) for modification of the width of the adhesive pre-metering nip (26).

21. An adhesive applicator unit according to claim 14,
wherein the adhesive re-metering roll (12) is adjustable in a horizontal setting direction (45) for modification of the width of the adhesive re-metering nip (28).

22. An adhesive applicator unit according to claim 15,
wherein the devices for maintenance of an adhesive level (31) are formed by an adhesive overflow (30).
